(19) United States
(12) Patent Application Publication
(10) Pub. No.: US 2018/0214838 A1
(43) Pub. Date: Aug. 2, 2018

(54) MATERIALS AND DEVICES

(71) Applicant: Cambridge Enterprise Limited, Cambridge, Cambridgeshire (GB)

(72) Inventors: Jeremy J. BAUMBERG, Cambridge, Cambridgeshire (GB); Tao DING, Cambridge, Cambridgeshire (GB); Ventsislav Kolev VALEV, Cambridge Cambridgeshire (GB)

(21) Appl. No.: 15/747,193

(22) PCT Filed: Jul. 28, 2016
(86) PCT No.: PCT/GB2016/052311

§ 371 Date: Jan. 24, 2018

(30) Foreign Application Priority Data
Aug. 4, 2015 (GB) 1513796.1
Apr. 19, 2016 (GB) 1606827.2

(51) Int. Cl. B01J 13/00; C08F 20/54

(52) U.S. Cl. CPC B01J 13/0065; B01J 13/0034; B82Y 15/00; C08F 2500/02; C08F 2500/03; C08F 20/54

(57) ABSTRACT

A reversible cycle phase change liquid comprises a polar working fluid, nanoparticles of a material having a density greater than 3000 kg/m³, and a controllable gel. The gel is switchable between hydrophilic and hydrophobic phases by application of a phase change driver. The gel coats the nanoparticles to a first thickness when the gel is in the hydrophilic phase and is swollen by the polar working fluid, and coats the nanoparticles to a reduced thickness when in the hydrophobic phase. The coated nanoparticles form clusters, or comprise individual unclustered nanoparticles, when the gel is in the hydrophilic phase, and form larger clusters when the gel is in the hydrophobic phase. In embodiments aggregation of the nanoparticles into clusters is self-limiting because of electrical charges on the nanoparticles, such that when the gel is in the hydrophobic phase the clusters remain soluble within the liquid.

### FIELD OF THE INVENTION

This invention relates to composite materials comprising coated nanoparticles dispersed in a fluid, and to applications of such materials.

The work leading to this invention has received funding from the European Research Council under the European Union's Seventh Framework Programme (FP7/2007-2013)/ERC grant agreement No. 320503.

### BACKGROUND TO THE INVENTION

So-called ‘smart’ polymeric materials, that is, polymeric materials which respond to a stimulus such as pH, temperature, an electric or magnetic field and the like, have been extensively studied for sensors, actuators and other applications. One class of applications is that in which energy such as heat is converted into some form of local or global physical movement, which can then be employed for an actuator or other purposes. However typical actuation forces at sub-micron scales are very low, often the forces can only be applied slowly, and control is hard to achieve.

One example of a material which has been suggested for such applications is the temperature-responsive polymer pNIPAM (poly (N-isopropylacrylamide)). The combination of pNIPAM with gold nanoparticles has previously been studied in: “Thermosensitive Gold Nanoparticles”, Ming-Qiang Zhu et al., J. Am. Chem Soc, 2004, 126(9), pp 2656; “Photothermally—triggered self-assembly of gold nanorods”, Daniele Fava et al., Chem. Commun., 2009, pp 2571-2573; “Room temperature synthesis of an optically and thermally hybrid PNIPAM-gold nanoparticle”, J. Ruben Morones et al., Journal of Nanoparticle Research May 2010, Volume 12 issue 4, pp 1401-1414; “Thermoswitchable Electronic Properties of a Gold nanoparticle/Hydrogel Composite”, Xiuli Zhao et al., Macromolecular Rapid Communications, Vol 26, pp 1784-1787, November 2005; and “New ‘smart’ poly(NIPAM) microgels and nanoparticle microgel hybrids: Properties and advances in characterisation”, Matthias Karg et al., Current Opinion in Colloid & Interface Science, Volume 14, issue 6, December 2009, pp 438-450.

Further background prior art can be found in: US2010/0255311; US2012/0107549; JP2001/261845A; and US2013/0295585.

However whilst some of these documents describe interesting behaviour they do not describe materials which are well-suited to practical applications. There therefore remains a need for materials which could, for example, provide effective operation of a nanoactuator. The desirable characteristics for such an application include a large force, fast operation, and repeatability.

### SUMMARY OF THE INVENTION

According to the present invention there is therefore provided a reversible cycle phase change fluid, comprising: a polar working fluid; nanoparticles of a material having a density greater than 3000 kg/m³; and a controllable gel; wherein said gel has a predominantly hydrophilic first phase having a first hydrophilicity and a predominantly hydrophobic second phase with a second, lower hydrophilicity, and is switchable between said phases by application of a phase change driver; wherein said gel coats said nanoparticles to a first thickness when the gel is in said first phase and is swollen by said polar working fluid, and wherein said gel coats said nanoparticles to a second, reduced thickness when in said second phase; wherein said coated nanoparticles form clusters with a first median nanoparticle number, or comprise individual unclustered nanoparticles, when the gel is in said first phase, and wherein said coated nanoparticles form clusters with a second larger median nanoparticle number when the gel is in said second phase.

In broad terms in embodiments of the material when the gel is driven from its second, predominantly hydrophobic phase to its first, predominantly hydrophilic phase, the clusters are ‘exploded’, in embodiments into individual nanoparticles. This creates a proportionally very large force because of the large stored elastic energy in the clustered state.

Thus the skilled person will recognise that as used herein a reversible cycle phase change fluid is a fluid (liquid) incorporating a gel which undergoes a phase transition, in embodiments a polymer which transitions between swollen and collapsed states. Typically the fluid (liquid) itself does not undergo a phase change as such, although there is a change from a dispersion of individual nanoparticles in the liquid to a dispersion of clustered nanoparticles in the liquid.

In embodiments the aggregation of the nanoparticles into clusters is self-limiting such that in the second phase the clusters remain soluble within the liquid. Thus in embodiments the number of nanoparticles in a cluster self-limits to a maximum number (dependent upon electrical charges within a cluster), rather than merely being limited by the number of available nanoparticles. More particularly, in preferred embodiments the (coated) nanoparticles are electrically charged and in this way the attractive forces between the nanoparticles when the gel is in its hydrophobic state are balanced by the electrical repulsion between the charges when the cluster reaches a limiting size. Typically the attractive forces are strong, arising from solvation forces including Van der Waals between the nanoparticles. Because of this very large elastic forces can be stored within the clusters, and liberated quickly by applying a phase change driver to switch the gel from its hydrophobic to its hydrophilic phase. Thus in embodiments a zeta potential of the fluid also varies between a relatively lower value when the gel is in its hydrophobic phase and an allegedly higher value when the gel is in its hydrophilic phase. Preferably the nanoparticles are relatively dense, preferably (though not essentially) with a density greater than 3000 kg/m³, so that the Van der Waals forces are relatively large.

In some preferred embodiments of the system when the gel is in its hydrophobic phase the coating on the nanoparticles is relatively thin, preferably less than 10 nm, 5 nm or 2 nm. This allows the coated nanoparticles to approach close to one another, thus increasing the stored elastic energy. This is facilitated in part, for example, by selecting the polymer to have less than a threshold number average molecular weight; as the skilled person will appreciate the precise number will depend upon the polymer employed.

In some preferred embodiments of the above and later described systems at least some of the polymer strands are free-floating floating in solution. These can then bind to the nanoparticle above Tc (and may release again when cooling below Tc). Thus in some preferred embodiments the working fluid includes free gel (polymer) molecules. This appears to be of significant benefit in providing making the assembly/disassembly process work efficiently. Thus in embodiments of the system the working fluid has molecules of the gel/polymer floating in a solution (of the working fluid), such that the molecules are able to bind to the nanoparticles as the nanoparticles form clusters. Preferably the molecules are also able to release from the clustered nanoparticles as the clusters disaggregate.

In preferred embodiments the nanoparticles are electrically conductive; more particularly they comprise metal nanoparticles. The metal preferably comprises a noble metal (ruthenium, rhodium, palladium, silver, osmium, iridium, platinum or gold), although in principle other metals, for example nickel, may also be employed. It has been established experimentally that nanoparticles with a minimum lateral dimension in the range 5 nm-300 nm are preferred. There is a preference against very small nanoparticles, for example with a minimum lateral dimension of less than 15 nm. Preferably the nanoparticles have the general shape of a spheroid (with a regular or irregular surface), as this facilitates aggregation, but this is not essential.

In embodiments the clusters are generally globular. In embodiments the median number of nanoparticles per cluster when the gel is in its hydrophobic phase is in the range 2 to 200, more typically less than 50 (though potentially up to 1000 or more). In embodiments the median number of nanoparticles in a cluster when the gel/polymer is in its hydrophilic phase may be substantially unity—that is in some preferred embodiments when the gel/polymer is in its hydrophilic phase the clusters are substantially completely disaggregated. In embodiments the gap size between clustered particles may be <10 nm.

In preferred embodiments the gel/polymer is attached to the nanoparticles by coordination bonding (rather than, for example, being covalently bonded). In this way the polymer chains appear not to be firmly anchored at a particular position on a nanoparticle. Without wishing to be bound by theory it is believed that the movement this enables facilitates the polymer phase transition, helping to avoid steric issues and tangling. In preferred embodiments the gel/polymer molecules are attached at sufficient distance from each other to facilitate a large (preferably the largest practicable) change in volume upon the polymer phase transition. One example is to attach them in the second, hydrophobic phase when, in embodiments, the polymers take on a globular form. This therefore appears to be a significant though not essential feature of a practical system.

In embodiments such coordination bonding may be achieved in a variety of ways, for example by providing the gel/polymer with a soft donor ligand (a noble metal nanoparticle typically comprises a soft acceptor). One example of such a ligand is an amino group (NH₂). Thus in some embodiments the polymer comprises an amine-terminated functional group. Other examples of ligands include carbonyl and nitrile groups—broadly speaking such a group has a loan pair of electrons that can donate to the nanoparticle.

Although coordination bonding is preferred for the reasons outlined above, nonetheless potentially covalent bonding may alternatively be employed, particularly if the polymer molecules are attached with sufficient space between them to facilitate the phase transition. Thus, for example, other ligands such as a thiol bond may also be effective, and in embodiments therefore the polymer may alternatively have a thiol termination.

Whilst techniques such as those described above, such as providing an amine termination on the end of the gel/polymer (e.g. PNIPAM) molecules, are preferable they are not essential. Thus in other approaches, for example, charge compensation of the nanoparticles may be employed while the polymer is binding. In embodiments screening/neutralising to compensate some of the charge may be achieved by employing a working fluid comprising a solution of a substance (salt) which is able to form a double layer around the nanoparticles, thus effectively making them less charged. In one example of this technique a 5 mM Mg²⁺ salt solution may be employed to form a double layer around gold nanoparticles. Additionally or alternatively this may be achieved by employing a working fluid comprising a protons, for example provided by an acid such as HCl—for example this can protonate the (citrate) charge on the gold nanoparticles making them significantly less charged. In systems of this type it is speculated that the polymer may warp around the nanoparticles.

In some preferred embodiments of the material the polymer comprises a stimulus-responsive polymer hydrogel—typically a three-dimensional cross-linked hydrophilic polymer chain network. Then, preferably but not essentially, the working fluid comprises water. The stimulus to switch the polymer between predominantly hydrophobic and predominantly hydrophilic phases may comprise any of a wide range of environmental stimuli including, but not limited to: temperature, pH, an electric field, a magnetic field, light, ionic strength, a chemical stimulus, and a biological stimulus. In some embodiments the phase change is triggerable by illumination with light at substantially the wavelength of an absorbance maximum of the working fluid (which effectively results in local heating).

In some preferred embodiments the polymer is a thermo-responsive polymer such as pNIPAM or a derivative or copolymer thereof, but the skilled person will appreciate that there are many other thermoresponsive polymers which may be employed. These include, for example, a range of polymers based upon poly(ethylene-glycol) (PEG), for example PEG methacrylate polymers (PEG MA). Other examples include poly(2-oxazoline)s; poly(N,N-diethylacrylamide) (PDEAAm); poly(N-vinylcaprolactame) (PVCL); poly[2]-[diemethylamino) ethyl methacrylate] (PDMAEMA); polymers/copolymers based upon glycerylmethylether (GME); poly(acrylamide)(PAM); and numerous variations on these. Typically such polymers exhibit a lower critical solution temperature (LCST) above which the polymer becomes hydrophobic, expelling water. In principle, however, a polymer exhibiting an upper critical solution temperature (UCST), above which the polymer and working fluid are miscible, may alternatively be employed.

In some preferred embodiments the gel comprises poly(N-isopropylacrylamide) (pNIPAM). In this case preferably the polymer has a weight (or number) average molecular weight of less than 10000 g/mol or less than 6000 g/mol, for example around 5500 g/mol. In some preferred embodiments the polymer has an amino termination forming the coordination bond with the metallic nanoparticle. This is discussed further below.

In some embodiments the nanoparticles may be constrained in how far they can move apart. This constraint may be achieved in a variety of different ways, for example by encapsulating the nanoparticles and working fluid and/or by tethering nanoparticles to one another with a molecular tether and/or by attaching nanoparticles to different parts of a physical structure such as an actuator which constrain the nanoparticles in proximity to one another. Such an approach can facilitate rapid switching.

The invention also provides an actuator having first and second mechanical parts which are moved in between different first and second positions relative to one another by the phase change of the fluid/gel. Such an approach may be used, for example, to control a hinge or trap door or any other movement of two mechanical parts relative to one another. Optionally in embodiments one or more nanoparticles may be attached to one or more of the parts. In this case a cluster of two or more of the (coated) nanoparticles may be formed by relative movement of the mechanical parts bringing the nanoparticles towards one another, and the parts may be forced away from one another, or other physical movement may be generated, when the polymer/gel of the coated nanoparticles becomes hydrophilic.

The skilled person will appreciate that there are many other potential applications of the material. For example the metallic nanoparticles exhibit an optical spectrum which changes substantially when the nanoparticles cluster, for example exhibiting a shift in absorption peak of greater than 50 nm, 100 nm or 200 nm. This can be seen as a colour change in the reversible cycle phase change fluid, and thus the fluid can be used to produce a switchable colour window or display. As used here, ‘colour’ may encompass ‘transparent’ and ‘black’ (as seen by a human observer). Such an optical device may comprise a chamber incorporating the reversible cycle phase change fluid with at least one optical window. For example a layer of the fluid may be retained between a pair of substantially transparent glass or plastic membranes or plates. The materials described herein lend themselves to-a-roll-to-roll manufacturing process for a flexible, large-area controllable window fabricated along these lines.

In a related aspect the invention provides a method of controlling a reversible cycle phase change fluid, the method comprising: providing a polar working fluid comprising metallic nanoparticles coated with a stimulus-responsive polymer having a predominantly hydrophilic first phase having a first hydrophilicity and a predominantly hydrophobic second phase with a second, lower hydrophilicity, wherein said polymer is switchable between said phases by application of a stimulus; wherein said metallic nanoparticles are electrically charged; and controlling said reversible cycle phase change fluid such that said polymer has said second phase and said coated nanoparticles cluster until an attractive force between said nanoparticles is balanced by a repulsive electrical force from said electrical charge of said nanoparticles; and applying a stimulus to said polymer to switch said polymer to first phase such that the polymer absorbs said polar working fluid and bursts said clusters to provide a physical force and/or control a physical property of said reversible cycle phase change fluid.

Preferred features of the method correspond to those previously described above with reference to the reversible cycle phase change fluid. Again as previously described, when the polymer becomes hydrophilic the clusters are effectively ‘exploded’ to generate a substantial force which can be used in many different ways. Broadly speaking the force arises from the stored elastic energy resulting from the balance of forces within a cluster between the large attractive forces between nanoparticles (from solvation/Van der Waals forces) and repulsive forces arising because the nanoparticles each carry an electrical charge (of the same sign). The electrical repulsive forces help to prevent complete aggregation of the nanoparticles and result in a self-limiting cluster size. In embodiments the size of cluster (and stored energy) may be controlled by controlling or tuning the (net) charge on a nanoparticle.

Thus in a related method there is provided a method of manufacturing a material, comprising: attaching a stimulus-responsive polymer to a metallic nanoparticle by coordination bonding, wherein said polymer is switchable between a predominantly hydrophilic first phase having a first hydrophilicity and a predominantly hydrophobic second phase with a second, lower hydrophilicity by application of a stimulus; wherein said attaching comprises mixing said nanoparticles with said polymer in a polar working fluid when said polymer is in said first phase; applying a stimulus to said polymer to convert said polymer predominantly to said second phase to reduce a thickness of said polymer coating on said nanoparticles such that said nanoparticles form clusters; and modifying said stimulus to convert said polymer predominantly to said first phase to increase a thickness of said polymer coating on said nanoparticles to disrupt said clusters.

Preferred embodiments of the method use electrical charge on the nanoparticles to limit the number of nanoparticles aggregating to form clusters. As the skilled person will appreciate, the charge may be controlled in many ways including, but not limited to: controlling the initial charge on the nanoparticles during their manufacture (for example by varying a characteristic of the process such as pH or the capping agent used); controlling an initial concentration of the polymer/gel coating during manufacture of the phase change fluid; controlling the polarity of the working fluid; and adding a salt, for example sodium chloride, to the working fluid; and in other ways. For example gold nanoparticles generated in aqueous solution by a citrate reduction method are typically negatively charged but the charge can be modified by using a different capping agent.

### Further Preferred Features and Aspects of the Above-Described Systems

We now describe further aspects of the above-described fluid/actuator/device/methods (for convenience referred to as systems).

One of the advantages of embodiments of the above-described systems is that they are able to generate relatively large forces on disaggregation, for example a lateral force per nanoparticle of greater than 0.1 nN, 0.5 nN, 1 nN, 5 nN or 10 nN (measured, for example, as described later).

In some preferred embodiments this large force may be achieved by using a polymer (gel) in which the average chain length is of a similar order to or preferably shorter than the entanglement length of the polymer. This may be equivalently expressed in terms of the weight (or number) average molecular weight of the polymer compared with the entanglement molecular weight, Me. Expressed in this manner the number of entanglements per molecule Z=Mw/Me is preferably is preferably less than (or equal to) 50, 20, 10, 5, or 1, where Me may be measured as set out below

It is believed that by using chains which have a length which is comparable to or shorter than the entanglement length allows the chains to expand and contract relatively freely resulting in higher forces. It is believed that this also allows the chains to expand and contract very rapidly (for example switching in <10 μs, 5 μs, or 2 μs), even though there is only a small gap between the nanoparticles in a cluster.

The high forces produced are also related to the relatively small gaps between nanoparticles. These small gaps are again facilitated by the relatively short polymer chain length, albeit where the gaps are small there is also a need for higher forces to overcome the higher Van der Waals attraction to be able to push the nanoparticles apart. In embodiments the polymer chains are sufficiently short for the nanoparticles to be plasmonically coupled to one another when clustered. This occurs when the gap between nanoparticles in a cluster is <10 nm. Alternatively plasmonic coupling may be identified by an absorption band spectral shift on clustering/aggregation of greater than 50 nm, 100 nm, 150 nm or 200 nm.

In embodiments the entanglement molecular weight Me (or equivalently, length) may be determined by the standard technique of measuring the plateau modulus G_{N}⁰, which can be determined by measuring the dynamic moduli G′ and G″ in an oscillatory shear experiment. Then Me can be determined from:

$${G}_{N}^{0} = \frac{4}{5} \frac{ρ RT}{{M}_{e}}$$

where ρ is the density of the polymer in its collapsed stare, R is the ideal gas constant, and T is the absolute temperature (standard room temperature may be employed). Density may be measured according to ISO 1183:1987, method D, with a mixture of isopropanol and di(ethylene glycol) as the gradient liquid.

The weight average molecular weight Mw and the molecular weight distribution (MWD=Mw/Mn wherein Mn is the number average molecular weight and Mw is the weight average molecular weight) may be measured by Gel Permeation Chromatography (GPC) according to a method based on ISO 16014-4:2003.

### BRIEF DESCRIPTION OF THE DRAWINGS

These and other aspects of the invention will now be further described, by way of example only, with reference to the accompanying figures in which:

FIG. 1 illustrates the manufacture and operation of a reversible cycle phase change fluid according to an embodiment of the invention;

FIG. 2 shows details and a theoretical model of the operation of a reversible cycle phase change fluid according to an embodiment of the invention;

FIG. 3 shows a nanoparticle cluster of a reversible cycle phase change fluid according to an embodiment of the invention;

FIG. 4 shows atomic force microscopy of nanoparticles clusters of a reversible cycle phase change fluid according to an embodiment of the invention;

FIG. 5 shows spectra illustrating reversible switching of tethered (encapsulated) nanoparticles of a reversible cycle phase change fluid according to an embodiment of the invention, and a corresponding SEM image;

FIG. 6 illustrates coated nanoparticles being driven from and returning to an oil-water interface, illustrating the forces involved when switching the phase change fluid;

FIG. 7 illustrates switching speed of a reversible cycle phase change fluid according to an embodiment of the invention;

FIG. 8 shows spectra of a reversible cycle phase change fluid according to an embodiment of the invention under a range of different conditions;

FIG. 9 shows the zeta potential of coated nanoparticles in the phase change fluid of FIG. 1 with different concentrations of polymer added;

FIG. 10 shows spectra of a reversible cycle phase change fluid according to an embodiment of the invention for different switching illumination durations;

FIG. 11 shows the effective diameter and zeta potential of coated nanoparticles in the phase change fluid of FIG. 1 under different environmental conditions;

FIG. 12 illustrates nanomachines using a reversible cycle phase change fluid according to an embodiment of the invention; and

FIG. 13 illustrates an actuator, a motor, and a switchable optical window using a reversible cycle phase change fluid according to an embodiment of the invention.

### DETAILED DESCRIPTION OF PREFERRED EMBODIMENTS

Broadly speaking we describe techniques which, in embodiments, bind temperature-responsive polymers to charged Au nanoparticles, storing elastic energy that can be rapidly released under light control for repeatable nano-actuation. Heating above a critical temperature T_{c}=32° C. using plasmonic absorption of an incident laser, causes the coatings to expel water and collapse to the nanoscale, allowing a controllable number of nanoparticles to tightly bind in clusters. Surprisingly, by cooling below T_{c} their strong van der Waals attraction is overcome as the polymer expands, exerting nanoscale forces per unit mass 25 times larger than previously achieved. The techniques are useful, inter alia, for the design of diverse colloidal nanomachines.

Thus we have designed a colloidal actuator system with high energy storage (>1000 k_{B}T/cycle) and fast (GHz) release mechanism. Based on gold spherical nanoparticles (Au NPs) coated with the amino-terminated polymer poly(N-isopropyl-acrylamide) (pNIPAM), this exploits the temperature responsive coil-to-globule transition at T_{c}=32° C. Below T_{c} the pNIPAM is hydrophilic and swelled by water inside the gel, but when heated above T_{c} it becomes hydrophobic and expels all water, collapsing to a volume many times smaller. We show that in the hot collapsed state, these stimulus-response-polymer coated, nano-particle-based systems—which we also refer to as actuating nano-transducers or ANTs—bind to neighbours but as soon as the temperature drops below T_{c} they are strongly pushed apart. Optical actuation is used to directly heat the AuNPs via the plasmonic photothermal effect, allowing remote control which is completely reversible. The resulting nanoscale forces are several orders of magnitude larger than any produced previously, with a force per unit weight nearly a hundred times better than any motor or muscle. Together with bio-compatibility, cost-effective manufacture, fast response, and energy efficiency, these deliver improved nano-device performance.

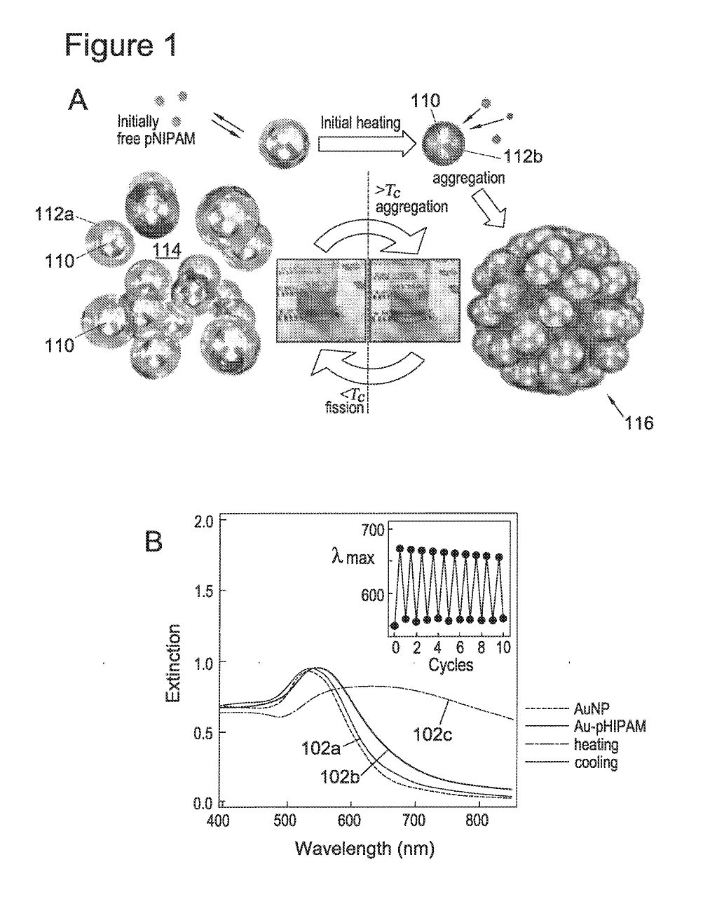

To construct these Au NP-pNIPAM actuating nanoparticles, 60 nm diameter citrate-stabilized Au NPs are functionalized with pNIPAM via ligand exchange above T_{c}. Referring to FIG. 1A, this shows nanoparticles 110 coated in a controllable gel (a stimulus-responsive, more particularly thermo-responsive, hydrogel) 112, which has a hydrophilic phase 112a in which working fluid 114 (such as water) is absorbed and a hydrophobic phase 112b in which the coating is collapsed and the water is expelled. In the collapsed, hydrophobic phase the nanoparticles form size-limited clusters 116.

In more detail, FIG. 1B shows the formation of pNIPAM-coated Au nanoparticles by mixing in solution, and then heating above T_{c}=32° C. to attach remaining pNIPAM onto Au. In the “deflated” state, the nanoparticles (NPs) aggregate tightly together. Cooling explosively splits clusters into individual NPs. Further heating and cooling results in reversible fission and aggregation.

The amino group on the chain end of the pNIPAM ensures strong binding to the Au surface, displacing citrate, while the hot assembly ensures the polymers attach in their globule state leaving enough lateral space for subsequent actuation. After initial ligand exchange, the absorption spectra of Au NPs only slightly red-shifts by 1.5 nm with no aggregation, indicating sparse coating of pNIPAM onto the Au with good stability.

FIG. 1B shows extinction spectra of Au NPs with (green, 102a) and without (black, dashed) attached pNIPAM (40 μM), under laser heating (red 102c) and cooling (blue 102b). The inset shows peak wavelength changes over successive cycles of laser heating and cooling.

A resonant laser (532 nm, 5 W) irradiating the ANT solution in a cuvette for 5 min increases the NP temperature to over 40° C. This is shown in FIG. 1g, which shows the temperature of Au NP solution for increasing irradiation time at the highest laser power on the cuvette, measured using an immersed thermocouple over long timescales. This gives a dramatic red-shift of the extinction peak to 645 nm (red line 102c in FIG. 1B). Blocking the laser beam rapidly cools the ANTs, and the extinction peak blue-shifts back to 539 nm (blue line 102b in FIG. 1B), almost recovering to the original state (at λₚₑₐₖ=535 nm). These spectral signatures are highly reproducible, repeating for many cycles (the inset of FIG. 1B; also described below). Similar constructs with 20 to 100 nm diameter Au NPs also work successfully. Thus FIG. 1h shows reversible nano-assembly of Au NP-pNIPAM clusters by light actuation, with Au NPs of diameters (from left to right), 20 nm, 60 nm, 80 nm, 100 nm. The curves in FIG. 1h show after initial addition of pNIPAM (green 102a), after laser heating (red 102c), and after cooling (blue 102b). As can be seen, the spectral shifts are very large (>200 nm).

Initially, extinction spectra were recorded during irradiation every 10 s while briefly shutting off the pump laser. FIG. 1C shows extinction spectral kinetics of a Au NP-pNIPAM (40 μM) mixture through one cycle of laser irradiation. The extinction peak remains stable at 536 nm in the first 30 s but increases steadily to 670 nm within 60s. This red-shift directly implies that the Au NPs come very close together with ever stronger coupling.

FIG. 1i shows theoretical extinction spectral peak positions from full electromagnetic simulations of straight (upper curve) and strongly kinked disordered (lower curve) chains of 40 nm Au NPs gaps of refractive index n=1.3 and gap size 0.9 nm. The electromagnetic simulations show that the gap between Au NP cores shrinks below 2 nm, attributed to the hydrophobic collapse of pNIPAM above T_{c}. After irradiation ceases, the plasmon resonance peak remains at ˜670 nm for 10 s followed by an extremely rapid blue-shift back to 539 nm with a time constant <1 s as soon as the pNIPAM drops below T_{c}. Such fast disassembly kinetics is due to the rapid swelling of pNIPAM and strong elastic forces exerted on the Au NPs.

Electron microscopy (SEM) images taken at different stages confirm this assembly process, as shown in FIG. 1D to 1F. These figures show SEM images of the system before (1D), during (1E), and after (1F), irradiating with 10 W for 5 min. The inset in FIG. 1E magnifies assembled pNIPAM-Au NP ANT cluster. Sampling was performed by dipping NH₂-functionalised Si substrates into the cuvette to capture the nanostructures (thus avoiding effects of drying-induced aggregation).

Initially the Au NPs remain well dispersed (FIG. 1D), but above T_{c} compact aggregates of Au NPs embedded in pNIPAM are found all over the substrate (FIG. 1E). The average aggregate diameter of 400 nm is comprised of an estimated 40 Au NPs. After cooling back down to room temperature, Au NPs collected in the same way show no aggregation at all (FIG. 1F). Hence the SEMs fully confirm the spectroscopic data. This laser-induced reversible shifting of plasmons occurs in the presence of NH₂-terminated pNIPAM and Au NPs with irradiation wavelengths around 532 nm (FIG. 1j). Were silver NPs to be used a different laser wavelength would be desirable to match a plasmon resonance. The pNIPAM should be attached to the surface of the NPs, preferably by a coordination bond such as an —NH₂ group. For example use of unterminated pNIPAM leads to unwanted flocculation of the polymer, showing no position change of the plasmon peak which recovers after laser is switched off.

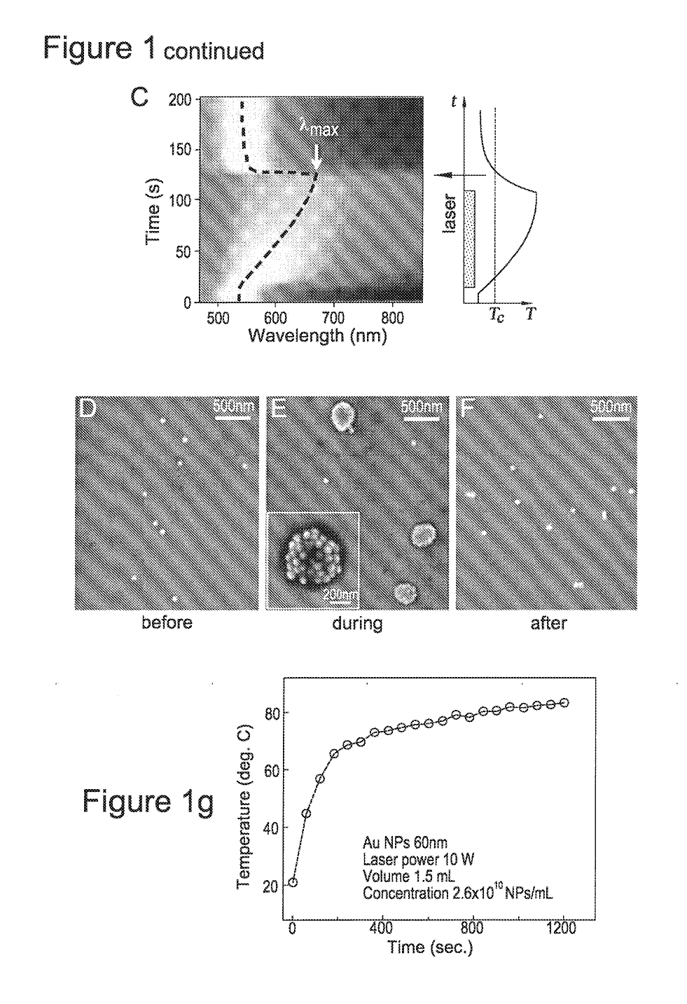

FIG. 2 illustrates investigations into the mechanism of reversible ANT assembly. This FIG. 2a shows changes of hydrodynamic size from dynamic light scattering (DLS) measurements, and FIG. 2b shows zeta potential measurements of the Au-pNIPAM assembly (the initial state is marked ∘), for 4 cycles of heating and cooling measured at 25 and 40° C. These measurements confirm the model of light-induced reversible tuning shown in FIG. 1A.

Initially, a sparse coating of amino-terminated pNIPAM displaces some of the charged citrate originally attached to each Au NP (∘). When the solution is heated above T_{c} (by light or heat) this pNIPAM collapses to globules and all other pNIPAM in solution quickly adds on top, yielding a thick coat and initiating aggregation to form weakly charged clusters, as indicated in FIG. 2B. Cooling the solution back down re-inflates the pNIPAM producing individual ANTs (red sol) coated with pNIPAM layers, 40 nm thick as estimated from their hydrodynamic diameter at 25° C. (FIG. 2A). These ANTs can then be repeatedly cycled from inflated (red, cold, isolated) to deflated (blue, hot, aggregated) states.

Actuation works when heating and cooling the solution around T_{c} (only ΔT=2° C. is enough to trigger the effects). A quantitative model is illustrated in FIG. 2C and described below. The model includes screened Coulomb, elastic, van der Waals, and surface forces.

Thus FIG. 2C shows the potential energy when bringing an extra ANT nanoparticle closer to a single cluster, in both hot (red 202b-d) and cold (blue 202a) states near T_{c}. When cold, the pNIPAM coat is inflated with water and the swelled ANTs just bounce off each other (blue curve 202a). In the hot state the potential energy depends on the number of NPs in the cluster as each contributes more repulsive charge. In more detail, when hot (red curve 202b) the outer pNIPAM coating collapses to only a few nm thick, and when NPs approach close to the cluster they feel strong van der Waals attraction between the Au cores, as well as an attractive solvation force (i). Increasing numbers of AuNPs join the cluster accumulating in the outer potential well, until the net charge (which is poorly screened by the hydrophobic collapsed pNIPAM) is enough to repel further NPs (yellow curves 202c,d; ii). After collecting a maximum number of NPs, the total cluster size saturates (FIG. 2A). This saturated cluster size is controllable through the initial charge on the Au NPs, or the addition of a small ethanol fraction, or salt concentration in solution, which tunes clusters from 4-10 NPs across (FIG. 2D). When cooled again, the pNIPAM returns to its inflated state (iii) but starting out highly compressed. The stored elastic energy in this state is very large, placing very large forces on the neighbouring NPs and exploding the cluster back to its constituents (iv).

Referring to FIG. 2D, this shows (left) the effective diameter of the Au NP-pNIPAM clusters in the hot state for increasing additional salt concentrations: Screening of the charge on each nanoparticle leads to a larger number of NPs in each cluster, increasing the effective hydrodynamic diameter in DLS. FIG. 2E also shows (right) the zeta potential in the hot, collapsed state, showing the reduction in charge for a fixed pNIPAM concentration (20 μM).

The stored potential energy is estimated as:

U=0.1Y_{c}\sqrt{R}t^{5/2}

where Y_{c}=1.8 MPa is the Youngs modulus in the cold state of pNIPAM, R is the radius of the Au NP, and t is the thickness of the pNIPAM layer when cold. This potential energy can reach 200-2500 k_{B}T for each cycle around this compression-expansion curve (the shaded region defined by (i)-(iv) in FIG. 2C), from individual pairs of ANTs, depending on their size and coating. The resulting expansion force

F=0.1Y_{c}\sqrt{R}t^{3/2}

is ˜25 nN for R=30 nm, t=40 nm. Since typical Brownian forces in solution are 1 pN, four orders of magnitude less, this is what forces the clusters apart into composite nanoparticles.

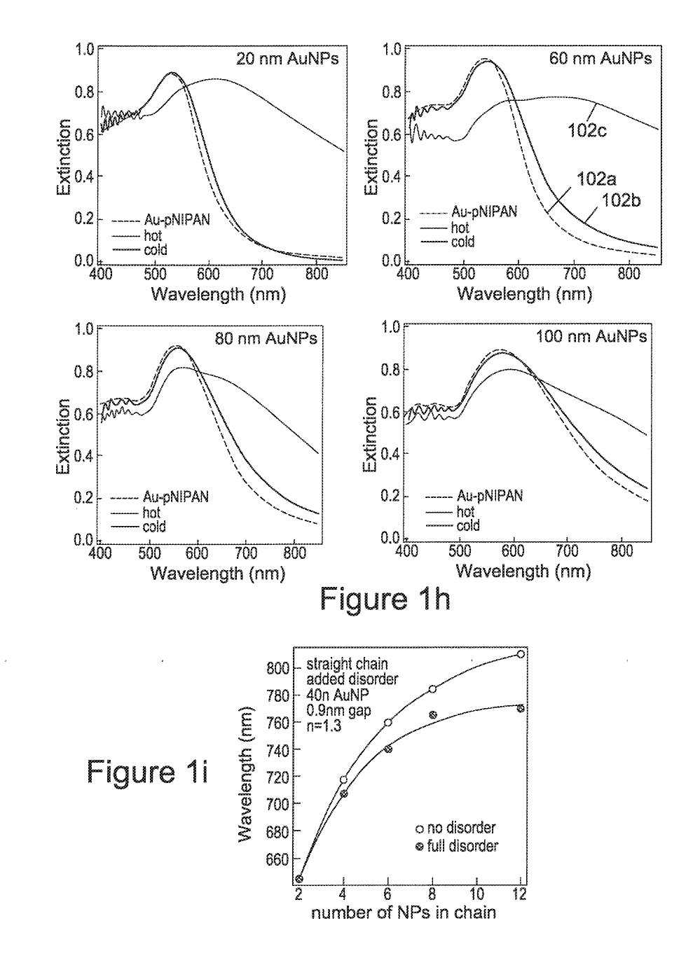

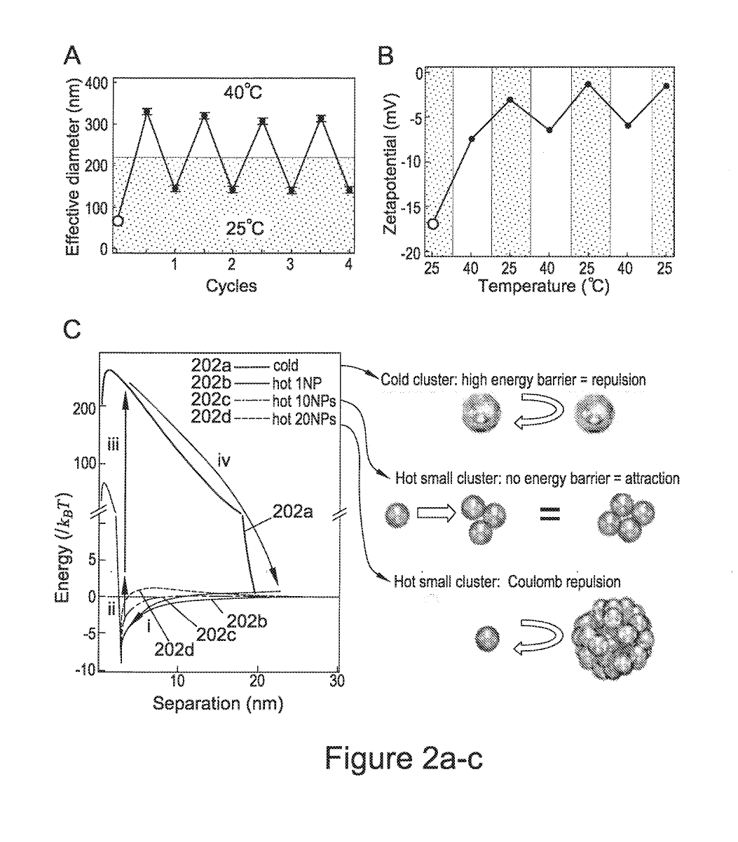

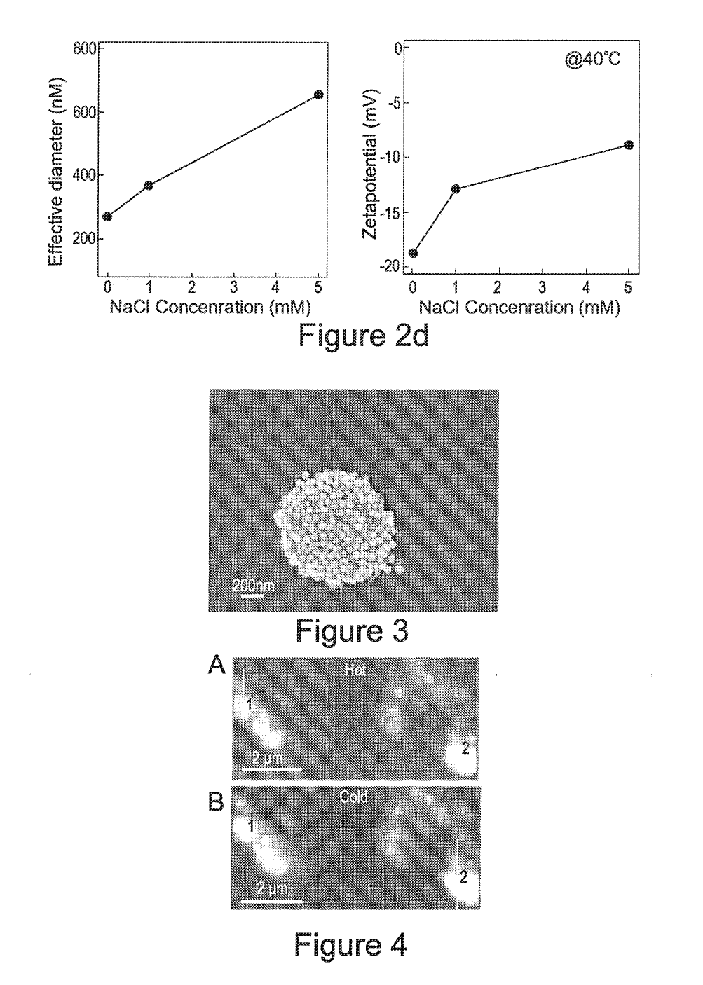

Further validation is provided by encapsulating individual hot ANT clusters (deposited onto a Si substrate) with a 70 nm-thick agarose film. Thus FIG. 3 shows SEM of a single ANT cluster spin-cast onto a silicon substrate in the hot state, after which a 70 nm-thick agarose film is spin-cast over the top to hold this in place. The agarose film allows the transport of water into and out of the cluster, while constraining the NPs together. FIG. 4 shows Atomic Force Microscopy (AFM) of clusters under encapsulating agarose film (as in FIG. 3). The same location on the sample is mapped by AFM in contact mode both hot (40° C.; FIG. 4A) and cold (25° C.; FIG. 4B). Cross sections used to determine the lateral extent of the cluster are indicated. The colour scale is from dark (0 nm) to light (200 nm). FIG. 5A shows SEM of a fixed ANT under agarose encapsulation on Si substrate (squashed more flat than in FIG. 3). FIG. 5A shows spectra of this fixed ANT cluster under agarose encapsulation, while changing the temperature from 25° C. to 35° C., showing the reversible switching. Insets show images of the cluster under microscope.

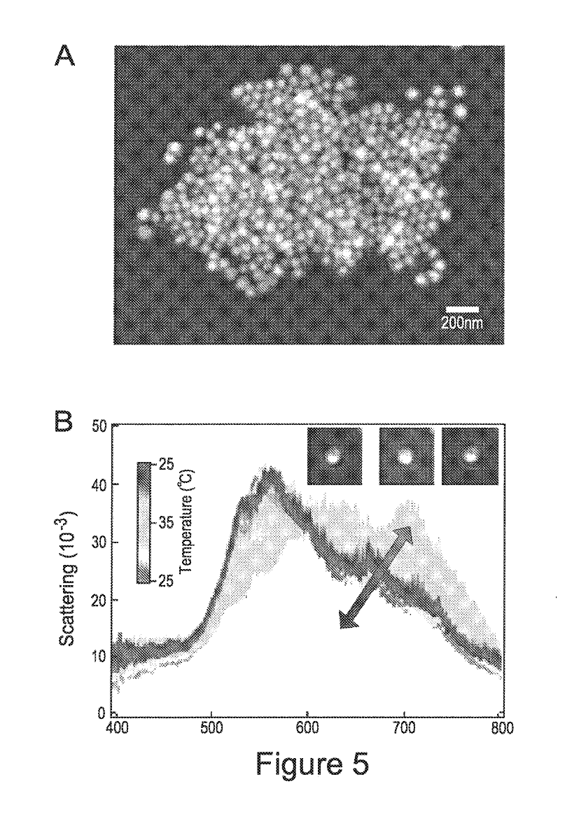

Upon cooling, the agarose is forced up around the cluster edges by the swelling ANTs which requires forces on the order of 100 nN (see later). Additional evidence for these strong forces is provided by observing ANTs in aqueous microdroplets within oil. While surface forces would normally permanently tether >10 nm Au NPs to water/oil interfaces completely reversible switching, with the 60 nm Au NPs pushed back away from the interface on each cooling, is observed. Thus FIG. 6 shows microscopy images of a single microdroplet containing pNIPAM and 60 nm AuNPs, being thermally cycled. The Au NPs originally in solution when cold (FIG. 6A) are driven onto the wall when heated (FIG. 6B; note the larger optical density at wall), before being ejected back off when the microdroplet is cooled (FIG. 6C). The scale bar is 20 μm. Optical transmission (FIG. 6D), and dark field scattering (FIG. 6E), while the ANT microdroplet is thermally cycled, as also illustrated.

Surveying macroscale to nanoscale actuators shows that forces scale with mass m, as log₁₀ F≃3+⅔ log₁₀ m, predicting maximum 1 nN forces from the NP structures described herein. The origin for the near-hundred-fold improvement demonstrated by embodiments of the invention apparently depends on van der Waals attractions between Au cores being very large in the collapsed pNIPAM state, setting up a tightly compressed pNIPAM spring which can be triggered into the inflated state. Our ANTs thus offers 25 times larger force/weight than any previous nanomachine, outperforming all current molecular motors (such as rotaxanes and kinesins), muscles, as well as mechanical and piezoelectric devices, and functioning a little like a nano-nematocyst.

### Theoretical Model for Interparticle Forces

Four forces were taken into account in the interaction between the clusters and an additional nanoparticle: the screened Coulomb repulsion, van der Waals attraction, elastic compression, and the surface energies. Using the normal DLVO formalism, the screened Coulomb repulsion for screening lengths smaller than the nanoparticle size is accounted for by

$${U}_{C} = 2 π ɛ N {ψ}_{0}^{2} R ln [ 1 + exp ( - \frac{d}{{l}_{d}} ) ] \qquad ( 1 )$$

with Au nanoparticle radius R, number of charged nanoparticles in each cluster N, gap between Au nanoparticle surfaces d, Deybe screening length l_{d}, surface potential ψ₀, and dielectric permittivity of solution ε. The van der Waals interaction is given in the close approach limit by

$${U}_{VdW} = \frac{A}{6} \{ \frac{2 {R}^{2}}{d ( d + 4 R )} + \frac{2 {R}^{2}}{{( d + 2 R )}^{2}} + ln \frac{d ( d + 4 R )}{{( d + 2 R )}^{2}} \} \qquad ( 2 )$$

with Au—Au Hamaker constant A=2.5×10⁻¹⁹ J (since the small pNIPAM van der Waals interactions can be ignored). The elastic contributions which arise when the pNIPAM is compressed in either the hot or cold states can be estimated from the compression of an elastic sphere against a flat surface as

Uₑ=0.11Y_{c}\sqrt{R}t^{5/2} (3)

where Y_{c}=1.8 MPa is the Youngs modulus in the cold state of pNIPAM, and t is the thickness of the pNIPAM layer coating each Au NP. Finally the surface energy of the pNIPAM contact in the hot state can be estimated, by estimating that log(Uₕₒₜ/k_{B}T)=0.5, as

Uₛ=−3k_{B}T for d<tₕ (4)

where tₕ is the thickness of the pNIPAM layer when it is in the hot collapsed state (with the hydrophilic pNIPAM in the cold state meaning that there is no interaction in the cold state).

Without these additional terms elastic and surface terms (3,4), the total potential reproduces the expected form with a potential barrier preventing aggregation for the initial Au NPs. The full potential is presented in both states in FIG. 2C, showing an additional minimum in the hot state just around contact. This energy minimum decreases as the cluster size N increases because of the enhanced Coulomb interaction with an additional nanoparticle, eventually limiting the total aggregation that is possible.

Forces

When agarose is used to encapsulate an ANT cluster (FIG. 3), the expansion as the pNIPAM cools acts to stretch the partially elastic film at the same time as peeling back the agarose films attached to the silicon around the cluster base. Given the typical Youngs modulus for the agarose films (which are 70 nm thick when dry), peeling back the agarose from the surrounding silicon as the ANTs push outwards has the lowest yielding point. AFM was used to map the lateral width and height of such clusters (FIG. 4) above and below the transition. While the height was not found to change significantly, the width of typical clusters slightly increases from 1.0 μm to 1.1 μm, though this is not easy to consistently map because the change in tip-sample interaction when the ANTs are cold gives additional lateral slip (observed as horizontal lines in FIG. 4B).

The force required to peel back the agarose film around a cluster of radius Y=0.5 μm is given by the relevant surface energies in the force of adhesion:

F_{adh}=2πYγ_{adh}

where γ_{adh}=γ_{agarose-H2O}+γ_{Si-H20}−γ_{agarose-Si}. Using estimated values for these interfacial tensions gives γ_{adh}=50-100 Jm⁻². The adhesive force overcome by the ANT is then F_{adh}˜5×10⁻⁷N. Assuming the cluster has n=10-20 NPs across its base, the estimated force available laterally from this cluster, using Eq. (2), is 25 nN. F_{adh}≃2−5×10⁻⁷ N, which agrees very well with that observed. This gives strong support to validate Eq. (2).

Further validation is provided by the incorporation of ANTs into microdroplets that allows similar reversible switching of the 60 nm Au NPs onto and off the oil-water surface. These 20 μm diameter microdroplets are formed in an oil phase (Pico-Surf 2, 5% in FC40) in a standard PDMS device, incorporating both pNIPAM and Au NPs in the water phase. Thermally switching the microdroplets (FIG. 6) shows that even such large nanoparticles can be reversibly brought back off the interface, due to the large forces available within the ANT energetic cycle. Although surface energies provide additional contribution to the forces, the fact that such it is possible here to bring the large Au NPs back off the oil-water interface is additional evidence for the strong forces involved.

Dynamical Timescales

The speed of the cluster expansion can be estimated from the speed of cooling and the diffusion of water back into the pNIPAM layer. Nanoparticles will cool in a time given by

$$τ = \frac{{R}^{2} {C}_{p}^{2}}{9 {C}_{f} {Λ}_{f}} \qquad ( 5 )$$

where C_{f} is the heat capacity (per unit volume) of the solvent, Cₚ is the heat capacity of the Au, and ∧_{f} is the thermal conductivity of the solvent. For the particles here this gives a cooling time ˜250 ps. The corresponding thermal diffusion length that is significantly heated around each Au NP

$${l}_{d} = \sqrt{\frac{τ {Λ}_{f}}{{C}_{f}}} \qquad ( 6 )$$

is <10 nm and so within the pNIPAM inflated shell. This will be modified by the thermal conductivity of the pNIPAM which is not well characterised.

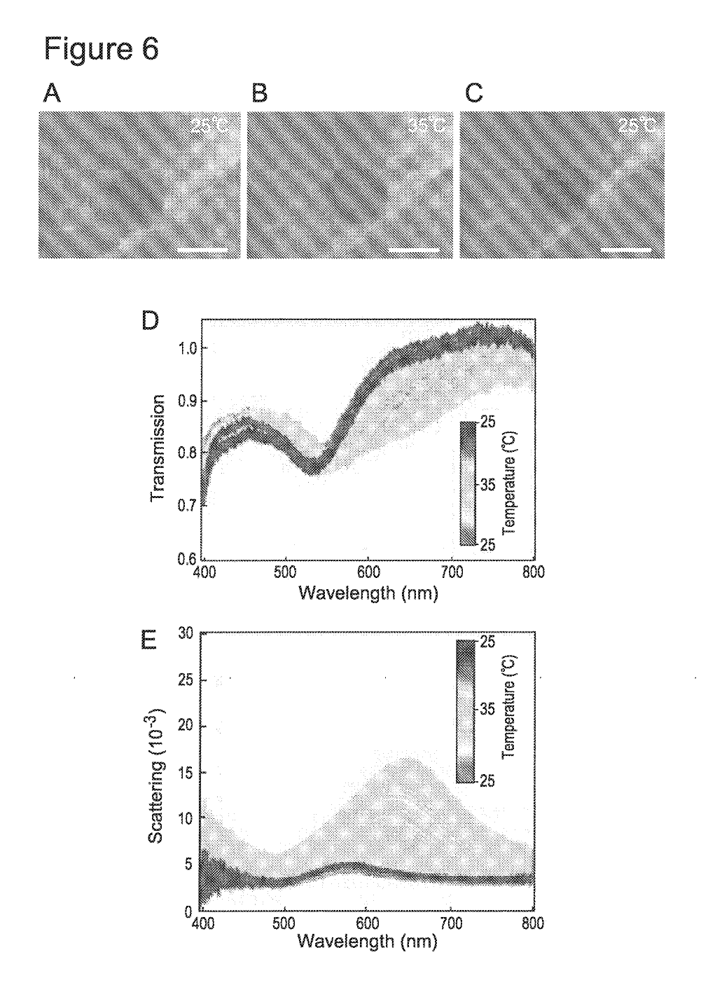

To confirm this predicted fast dynamics directly, we used single ANTs encapsulated by agarose sheaths as discussed above. A 635 nm diode laser was used to excite this encapsulated ANT, producing the reversible scattering spectrum shown in FIG. 5. We modulated the diode laser directly, and used a simultaneous incandescent white light source to provide real-time scattering information. To remove effects of pump scatter, we filtered the dark-field scattering through cut-off filters, and integrated the signal above 700 nm into a photomultiplier. Although this scattering from a single ANT is small, one can use fast amplifiers to directly access the switching on microsecond timescales. Thus FIG. 7 shows that the spectral shifts are at the instrumental time resolution <2 μs—faster than video rate, six orders of magnitude faster than has previously been achieved, and useful for building effective devices.

In more detail FIG. 7A shows dark-field scattering of an encapsulated cluster, with additional spectral filters to exclude all light λ<700 nm. Focussed 0.5 mW 635 nm diode laser switches cluster periodically into the hot state, in which scattering is much stronger. FIG. 7B shows time-resolved switching of encapsulated an ANT, showing <2 μs rise time, which is that of the instrumental resolution (oscillations observed in the electrical response come from the imperfect amplifier impedance matching).

Characterisation

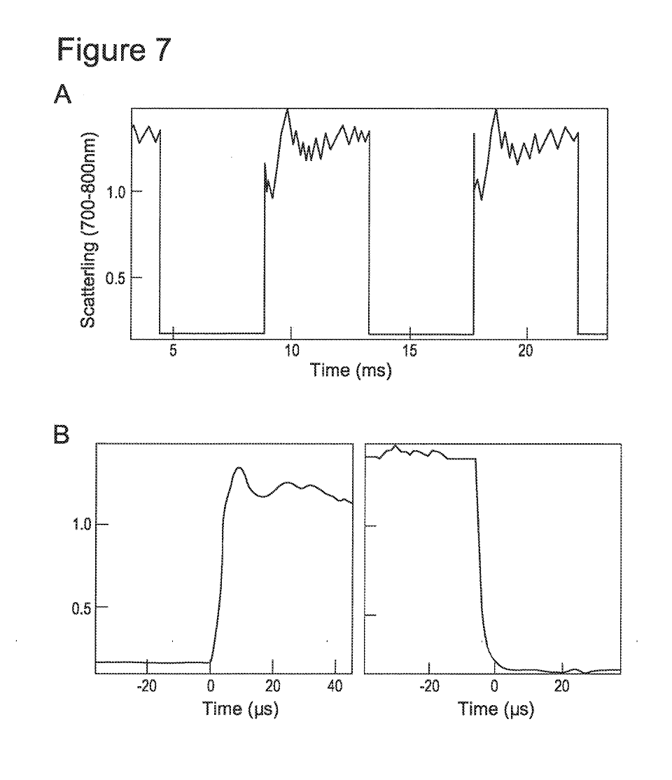

Our understanding of the light-triggered actuation allows further tuning of the nano-assembly and plasmonic spectra by varying pNIPAM concentration, laser irradiation time and power. This is illustrated in FIG. 8, which shows extinction spectra of an Au NP-pNIPAM system at different concentrations of pNIPAM (FIGS. 8A, 8B), different irradiation times (FIGS. 8C, 8D), and different irradiation powers (FIGS. 8E, 8F). FIGS. 8B, 8D and 8F show the corresponding extracted longitudinal coupled plasmon mode wavelengths from FIGS. 8A, 8C, and 8E.

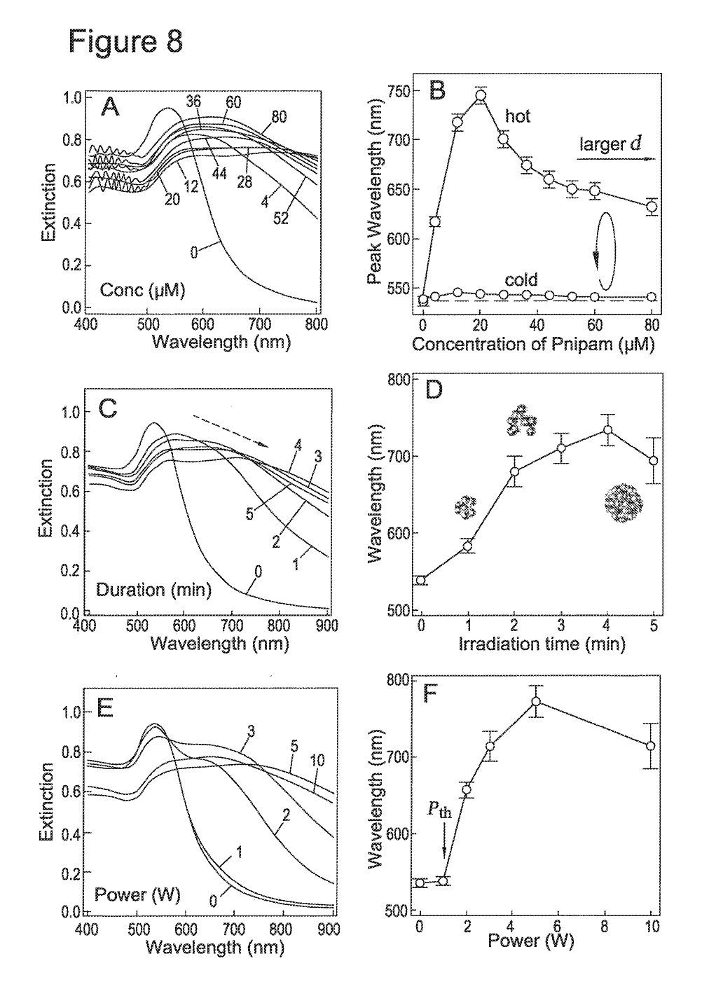

FIG. 9 shows the change of zeta potential of Au NPs with different concentration of pNIPAM added, recorded immediately after addition of pNIPAM. It can be seen that the initial pNIPAM concentration controls the surface charge of the Au NPs, which determines the saturation size of the clusters.

For pNIPAM concentrations below 20 μM, the plasmon resonance peak can redshift to 745 nm, while further increases in concentration decrease this maximal red-shift (FIG. 8A, 8B). When less pNIPAM is used, the surface charge of Au NPs is still strong enough to prevent excessive aggregation. When excess pNIPAM is used it increases the coating thickness, spacing the Au NP cores further apart within the cluster and decreasing the maximum red-shift. In either case however, the ANTs recover to their initial state around 535 nm.

Irradiation times influence the temperature of the ANTs (FIG. 1g), changing the kinetics of pNIPAM assembly onto Au NPs (FIG. 8C, D). Initially as irradiation times increase, the clusters grow, eventually limited by their charge balance. Similar effects are seen with increasing laser powers as long as they exceed the Pₜₕ˜1 Wcm⁻² threshold needed to trigger the thermal transition (FIG. 8E, F). Small blue-shifts at the highest powers or longest times can arise with rearrangement of AuNP clusters from nonspherical aggregates into more compact arrangements. Once the ANTs have formed however, in all cases the extinction spectra almost completely recover to the initial wavelength after cooling.

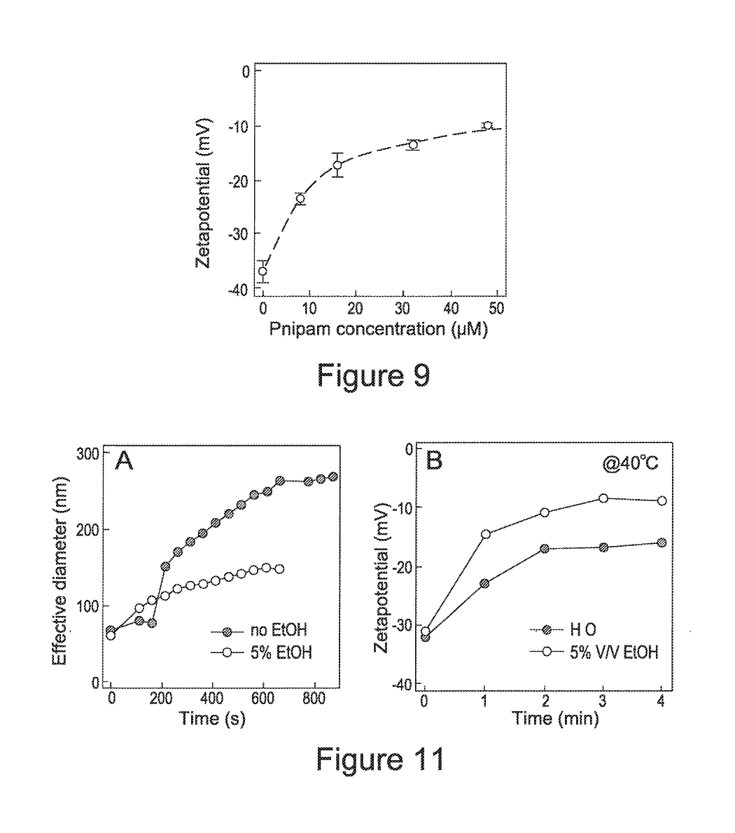

FIG. 10 shows extinction spectra of Au-pNIPAM (20 μM) dispersion with different durations of 10W laser irradiation, 1 min (FIG. 10A), 2 min (FIG. 10B), 3 min (FIG. 10C), 4 min (FIG. 10D), 5 min (FIG. 10E). The sharp lines at 532 nm arise from subtracting out the green laser line. FIG. 10F shows the maximum shift of wavelength with different irradiation time. FIG. 10 illustrates that laser irradiation does not cause irreversible aggregation, due to the strong elastic repulsion between ANTs.

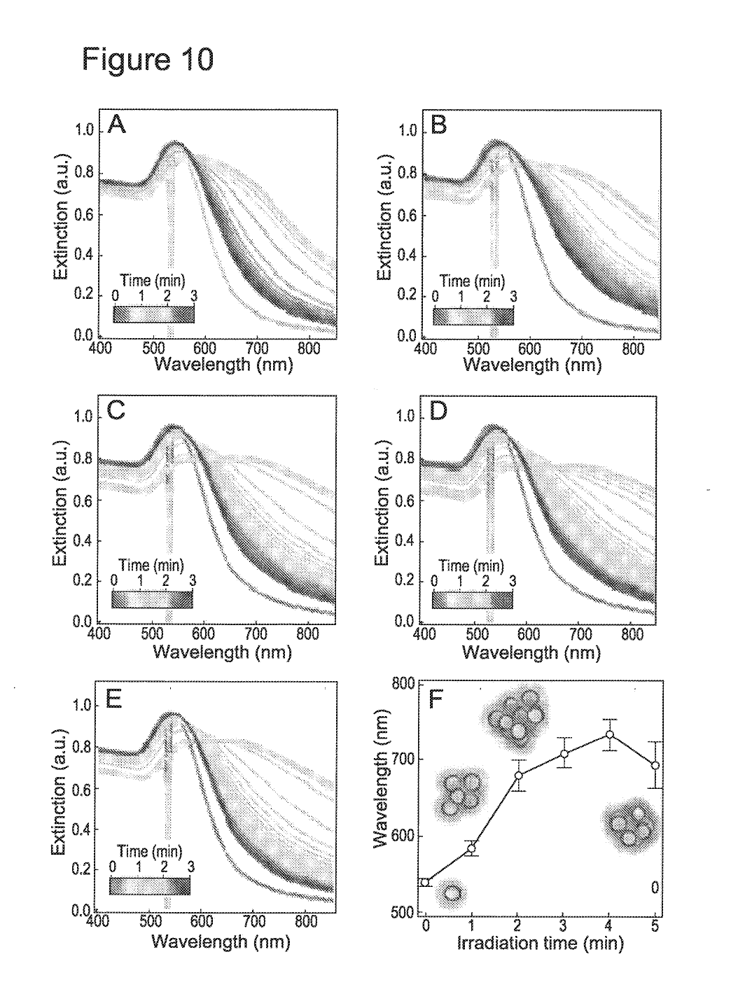

Embodiments of this colloidal actuator enables remote, light-operated control of nanodevices through reversible expansion between AuNPs. Fabrication of the actuator nanoparticles on a large scale and their operational mechanism are both simple. They are compatible with aqueous environments and work at room temperature, with T_{c} tuneable in many ways, such as by pH or ethanol fraction. Thus referring to FIG. 11A, this shows the effective diameter measured in DLS of the AuNP-pNIPAM clusters in the hot state for increasing irradiation times, showing the growth and saturation of the cluster size. Adding ethanol (EtOH) decreases the change in enthalpy on solvation of the pNIPAM at the critical temperature transition. FIG. 11B shows extra reduction in zeta potential of Au NPs at fixed pNIPAM concentration (20 μM) with the addition of 5% EtOH.

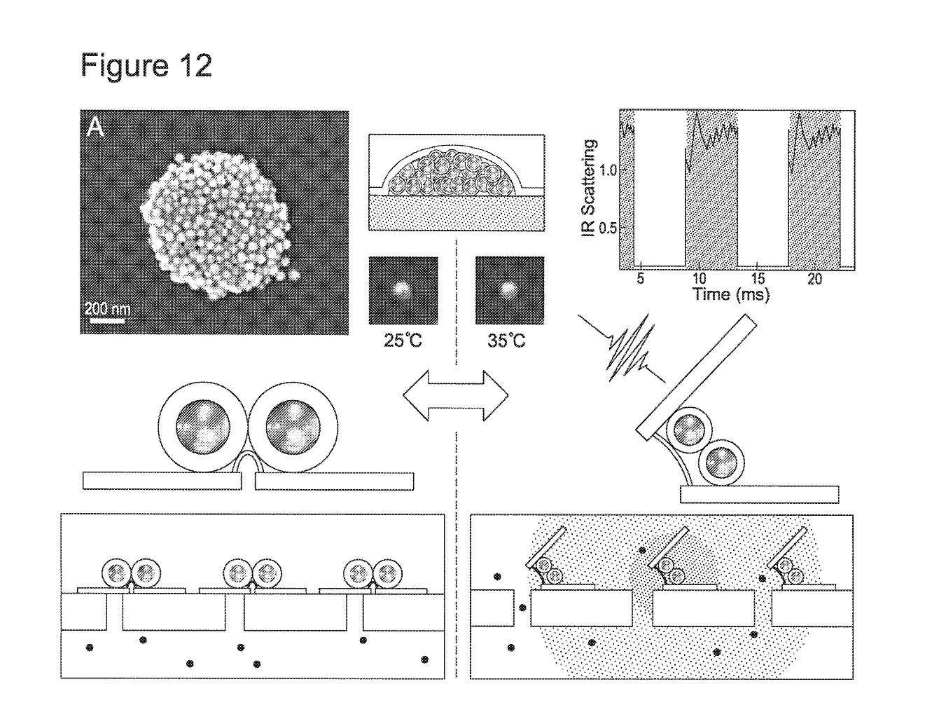

As previously mentioned, the NPs we describe may be encapsulated or tethered to one another. Thus FIG. 12A shows an SEM image of an agarose-encapsulated ANT cluster on Si, whilst FIG. 12B shows a schematic view of this (top) and dark-field scattering images when hot and cold (bottom). FIG. 12C shows the scattering dynamics (integrated from 700-900 nm) as 0.5 mW 635 nm laser is modulated (red).

FIG. 12 also illustrates the dynamics of nanomachines based on the systems we describe, in particular showing in FIG. 12D one example of an ANT-powered nanomachine, in which tethered ANTs irradiated by light “cluster”/“explode” to close and open hinged jaws. Active hinges and/or trapdoors of the type illustrated may be fabricated by tethering single or pairs of core-shell NPs onto “DNA origami” or other microscale or nanoscale constructs. In embodiments solution-assembly onto perforated films enables optically powered separation membranes.

Estimates of the heating and cooling rates (described above) suggest sub-ns switching enabling up to GHz-rate cycling and yielding powers˜nW/nanoparticle with potentially high efficiency. Indeed optical triggering of single agarose-encapsulated clusters of the type illustrated in FIGS. 12A-C show <2 μs switching, limited by our system response (FIG. 7), around 10⁶ times faster than typical pNIPAM switching.

Providing sufficient attractive force in the collapsed pNIPAM state to bind NPs, while being not too strong to prevent them being pushed apart when switching the pNIPAM to the inflated state, is a balance to be achieved in the system. In embodiments which use Au NP cores, it is possible to see and calibrate the process in real time as the pNIPAM coating thickness collapses from 40 nm to 1 nm, since the colour is a very sensitive indicator of their separation. The high optical cross-section of plasmonic Au NP cores enhances local excitation, with light reducing the total heat needed to switch the pNIPAM surrounding each NP. While Au cores thus have useful properties, van der Waals forces between most metallic cores would also work. Important for reversibility here is the charging limit on cluster size, without which clusters grow large and insoluble. This is due to exclusion of water from around the clusters, which allows incoming NPs to see the total (unscreened) charge.

Without wishing to be bound by theory it is believed that at least in some instances, a cluster may have a core of the gel, surrounded by the Au nanoparticles (rather than a core of solid Au nanoparticles). In practice there may be a mixture of types of cluster.

Experimental Methods

To prepare one example of a system according to an embodiment of the invention, comprising Au-pNIPAM reversible assembly core-shell nanoparticles, Au or Ag NPs are obtained from a supplier such as Sigma-Aldrich or fabricated by methods well known to those skilled in the art, for example to provide citrate-capped NPs. In one approach 0.5 ml of Au or Ag NPs were mixed thoroughly with different amounts of NH₂-terminated pNIPAM polymer solution (10 mg/ml, M_{w}˜5000, Sigma-Aldrich) and injected into a cuvette (2×10×40 mm³) for laser irradiation and extinction spectroscopy measurements. The cuvette was placed inside a 4-port cell (Thorlab) through which the laser beam (532 nm) of controlled power was collimated while the probing white light transmitted beam was detected in the orthogonal direction via an optical-fiber-coupled spectrometer (Ocean Optics, QE6500). The laser beam was briefly shuttered every 10 s to allow accurate measurement of the probe beam spectrum, with total irradiation times varying up to 10 min. Initially the irradiated nanoparticles float upwards leaving the area probed by the spectrometer, however within a few seconds the heated NPs fill the cuvette throughout the region probed by the spectrometer. Thus spectral data can be delayed by up to 3 seconds. After irradiation, the laser was totally shut off allowing the nanoparticles to cool down while the probe beam spectra were recorded every second. The sampling for scanning electron microscopy was carried out at different stages of assembly by inserting NH₂ functionalized Si substrates (using 3-aminopropyl tetraethoxysilane, APTES) into the solution for 1 min. The amino group allows Au NPs and their assemblies to absorb onto the substrate without losing their configuration after being taken out from the solution. The residual liquid on the substrate was immediately removed with tissue paper to avoid drying-induced aggregation of Au NPs. The SEM imaging of the samples was carried out with accelerating voltage of 5 kV on a LEO 1530VP (Zeiss). The temperature of the solution could be separately measured via a temperature-sensitive resistor. The DLS and zeta potentials of Au-pNIPAM colloids were measured with a ZetaSizer (Malvern) at 25 and 40° C., respectively.

To encapsulate the clusters, they were formed as above after cycling the Au-pNIPAM solution four times, and then in the hot state drop cast onto a heated silicon wafer. Warm agarose (Bioline, gelling temperature 38.7° C.) solution was then spin-cast onto this substrate to provide a water-permeable membrane that stops the NPs from dissociating into the cold state (FIG. 3). The thickness of the agarose film was determined to be 70 nm. In the encapsulation, the spherical cluster shape is flattened into a dome (FIG. 12B) with diameter 1 μm and height 200 nm. It was confirmed that the switching of these clusters was maintained, showing the characteristic spectral shifts seen in the solution ANTs (FIG. 5).

### Example Applications

Stimulus-response-polymer coated, nano-particle-based systems of the general type described above are potentially of utility for many applications including remotely-controlled dynamic assembly for nanomachines such as “DNA Origami”, as well as wallpaper-scale optics, for instance as non-fading large-area photochromics for buildings. Thus structures of the type shown in FIG. 12D can be used, for example, to gate the motion of molecules through small holes, for selective filtering applications. In this case local (selective) actuation is also possible using (selective) illumination by light overlapping an absorbance peak of the system. A (large-scale) film of this type may thus be provided with perforated pores which may be actively controllable to modify flow through on the fly.

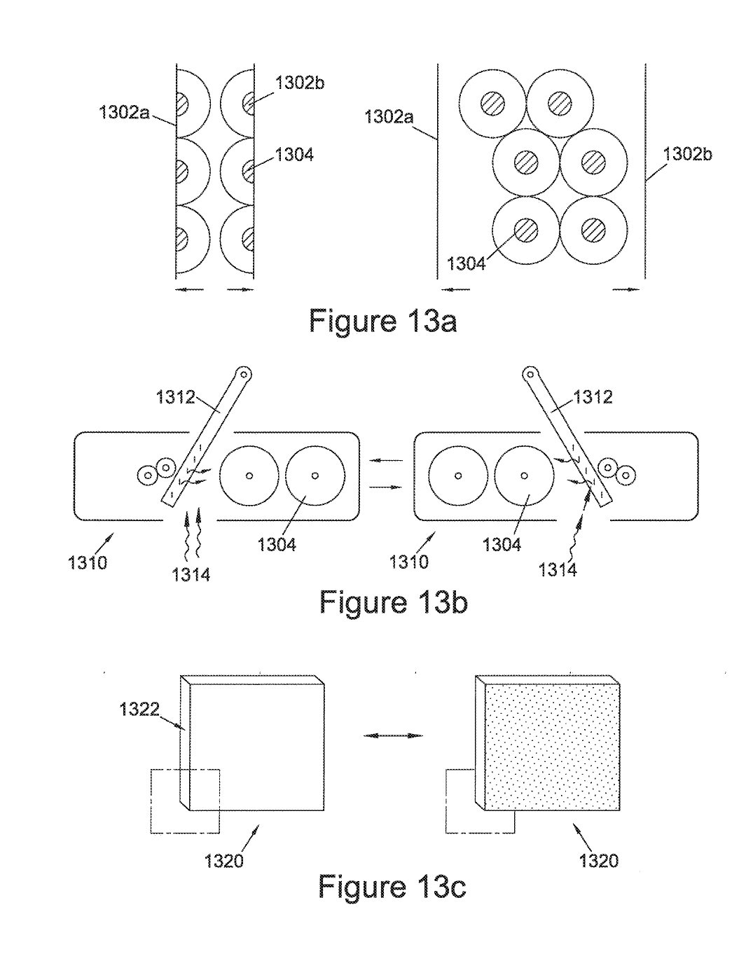

Referring now to FIG. 13A, this shows an example of the phase change fluid disposed between a pair of plates 1302a,b. Actuation from core-shell spheres 1304 in layers or a volume between the plates may be used to apply a collective rapid force on the plates upon cooling from above to below Tc. An actuator of the general type shown in FIG. 13a has been successfully fabricated using a single ANT particle, which was provided, together with a small amount of water, between two walls. When the particle expands (contracts) it pushes (pulls) against the walls.

In another example application the reversible phase change fluid may be used to drive a motor. Thus, for example, FIG. 13B shows a flip-flop motor 1310 constructed to use the core-shell NPs 1304 in an enclosure that traps NPs on either side of a lever 1312. The motor is arranged so that (laser) light 1314 reflects off the lever to illuminate the core-shell NPs 1304 on one side of the lever to drive the lever to a position where light reflects to illuminate the core-shell NPs 1304 on the other side of the lever. Thus the left hand drawing shows an initial state with hot collapsed NPs on the left and cold inflated NPs on the right side of lever. Laser light bounces off the reflecting lever and starts to heat the right NPs at the same time as the left NPs start to cool. In the right hand drawing the NPs swap size and flip the lever to the right. The laser now starts to heat the left side and the right side cools, leading shortly to a flop back of the lever to the position shown in the left hand drawing.

Another application for the system is to provide a simple, cheap, reversible colour changing large area film. The colour may change, for example, from transparent to opaque as the light level or temperature rises. Thus FIG. 13C shows a thin gap or layer 1322 within (the thickness of) in a window 1320 containing core-shell NPs which switch transparency as heated by outside light

More generally one can envisage various ways to harness the effects described above, into actuation devices. Note that Tc can be tuned in a variety of ways including by means of the solvent (working fluid) and precise polymer used. Modes in which collections of these core-shell NPs are used together provide the benefits of easy production and insertion into active joints, fast motion, scalable forces dependent on the number of NPs, and production of heat locally at the joint (for instance electrically additionally or alternatively to optically). Thus other applications include (but are not limited to): smart optics (changes colour/light absorption for example on temperature/chemical change); opening holes in a film to allow molecules to diffuse through (for example light, heat, or chemical trigger); propelling biomedical devices in the body; use in a drug-release device/system; pumps/valves powered for example by light in for example microfluidics (for example for microdiagnostics, lab on a chip); and active filtration through films.

### SUMMARY

Broadly speaking we have described a composite nanoparticle which is able to act as the heart of a nanoactuator. It first binds to its neighbour, and then strongly pushes it away, depending on a trigger, which may be a small temperature change, a change in illumination, a pH change, a change in electrochemical potential, or some other trigger. The process is completely reversible. The force is several orders of magnitude larger than anything achieved previously, and the force per unit weight is over ten times better than any motor or muscle.

The system has a number of significant advantages: water compatible (so good for ambient conditions, non-toxic, biocompatible); operates around room temperature, or body temperature (and is controllable); can be very fast (sub-ns); can be energy highly efficient; is very simple and cheap to manufacture; is optically controllable (so no wires needed); can be tuned (to many specific conditions desired); has a relatively generic but mechanism; produces colour changes when actuated, so can be easily tracked (or this can be used).

In embodiments the polymer (for example pNIPAM) is attached to the metallic nanoparticles through coordination bonding. Such an attachment is particularly thermodynamically stable in aqueous solution. In one preferred embodiment amino terminated pNIPAM is employed, preferably with a molecular weight lower than 6,000 g/mol; this forms a coordination bond between the —NH2 and the noble, for example gold, nanoparticle.

Preferably the polymer to nanoparticle attachment (for example the —NH2 to Au attachment) is carried out in the hot state when the polymer is in the hydrophobic state (for pNIPAM, when this is in the globule state so in a compact sphere rather than as long chains). Preferably a noble metal is used for the nanoparticles; preferably these have a size of the nanoparticles of larger than 10 nm or 15 nm so that relatively strong Van de Waals forces are produced. As previously described, in embodiments Au/pNIPAM “raspberry-like” hybrid cluster structures are formed with a close-packed arrangement.

In embodiments the system operates by water exclusion and then hydration of the polymer chains, which release the elastic energy stored when compressed (collapsed). In embodiments the cluster size is self-limiting, preferably but not essentially by means of surface charges of the clusters after certain number accumulation of nanoparticles (when the Coulomb force is strong enough to stop another charged Au NPs coming into the cluster thereby limiting the growth of the whole cluster). In embodiments the system provides a spectral tuning from collapsed to expanded state which produces a wavelength shift of greater than 100 nm. Where light selective triggering of the switch between collapsed and expanded polymer states is employed this works best when the laser wavelength is approximately on the resonance of maximum absorbance. In some preferred embodiments the coating of pNIPAM is thin enough (<1 micron thick) to ensure a rapid dynamic response on heating the NP directly. The coated nanoparticles (for example pNIPAM:Au NPs) may be tethered together, as described above by agarose encapsulation but also, for example, by tether molecules (which can provide a longer tether). In this case in the cold state the NPs do not move far apart, and so when heated they can find each other faster.

No doubt many other effective alternatives will occur to the skilled person. It will be understood that the invention is not limited to the described embodiments and encompasses modifications apparent to those skilled in the art lying within the spirit and scope of the claims appended hereto.

1. A reversible cycle phase change fluid, comprising:
a polar working fluid;
nanoparticles of a material having a density greater than 3000 kg/m³; and
a controllable gel;
wherein said gel has a predominantly hydrophilic first phase having a first hydrophilicity and a predominantly hydrophobic second phase with a second, lower hydrophilicity, and is switchable between said phases by application of a phase change driver;
wherein said gel coats said nanoparticles to a first thickness when the gel is in said first phase and is swollen by said polar working fluid, and wherein said gel coats said nanoparticles to a second, reduced thickness when in said second phase;
wherein said coated nanoparticles form clusters with a first median nanoparticle number, or comprise individual unclustered nanoparticles, when the gel is in said first phase, and wherein said coated nanoparticles form clusters with a second larger median nanoparticle number when the gel is in said second phase.

2. A reversible cycle phase change fluid as claimed in claim 1
wherein aggregation of the nanoparticles into clusters is self-limiting such that in the second phase the clusters remain soluble within the liquid.

3. A reversible cycle phase change fluid as claimed in claim 1 wherein said coated nanoparticles are subject to an attractive force to bind said coated nanoparticles into a cluster when the gel is in said second phase, and wherein said nanoparticles are electrically charged such that said attractive force is balanced by said electrical charge to stabilise a size of said clusters when the gel is in said second phase.

4. A reversible cycle phase change fluid as claimed in claim 3 wherein a zeta potential of said reversible cycle phase change fluid varies between a first, lower value when said gel is in said second phase and a second, larger value when said gel is in said first phase.

5. A reversible cycle phase change fluid as claimed in claim 1 wherein said nanoparticles comprise metallic nanoparticles having a minimum lateral dimension of 5 nm.

6. A reversible cycle phase change fluid as claimed in claim 5 wherein said nanoparticles have a minimum lateral dimension of at least 15 nm and a maximum lateral dimension of no more than 300 nm.

7. A reversible cycle phase change fluid as claimed in claim 5 wherein said gel comprises a polymer attached to said nanoparticles by coordination bonding.

8. A reversible cycle phase change fluid as claimed in claim 7 wherein said working fluid comprises water and said polymer comprises a stimulus-responsive polymer hydrogel, switchable between said first and second phases by a stimulus comprising said phase change driver.

9. A reversible cycle phase change fluid as claimed in claim 7 wherein said polymer has an amino termination forming said coordination bond with said metallic nanoparticle.

10. A reversible cycle phase change fluid as claimed in claim 1 wherein said polymer comprises pNIPAM with a weight average molecular weight of less than 6000 g/mol.

11. A reversible cycle phase change fluid as claimed in claim 1 wherein said phase change driver comprises said gel comprises a thermoresponsive polymer.

12. A reversible cycle phase change fluid as claimed in claim 1 wherein said phase change is triggerable by light at substantially the wavelength of absorbance maximum of said working fluid.

13. A reversible cycle phase change fluid as claimed in claim 1 wherein, when said gel in a said second phase, said second median nanoparticle number is in the range 2 to 200 and wherein, when said gel is in a said first phase, said first median nanoparticle number is substantially unity.

14. A reversible cycle phase change fluid as claimed in claim 1 further comprising a molecular tether or encapsulation such that said coated nanoparticles are constrained together when said gel is in said first phase.

15. A reversible cycle phase change fluid as claimed in claim 1 wherein said gel comprises a polymer, and wherein a ratio, Z, of weight average molecular weight of the polymer, Mw, to an entanglement molecular weight, Me, of the polymer, where Z=Mw/Me, is less than 50, more preferably less than 20, 10, or 5, most preferably less than 1.

16. The reversible cycle phase change fluid of claim 1 incorporated in an actuator comprising first and second mechanical parts wherein, when said gel is in said first phase said first and second parts are in a first position relative to one another, and when said gel is in said second phase said first and second parts are in a second, different position relative to one another; and wherein movement of said parts between said first and second position is driven swelling of said gel of said coated nanoparticles to disaggregate said clusters.

17. The reversible cycle phase change fluid of claim 16 wherein each of said first and second parts bears one or more of said coated nanoparticles, and wherein a cluster of said coated nanoparticles when said gel is in said second phase comprises a cluster of two or more of said coated nanoparticles formed by movement of said first and second parts bringing said one or more coated nanoparticles on said first and second parts together.

18. The reversible cycle phase change fluid of claim 1 incorporated in a switchable optical device in a chamber with at least one optical window, wherein the optical device is reversibly switchable with said phase change driver to exhibit a first colour when said gel is in said first phase and a second colour when said gel is in said second phase.

19. A method of controlling a reversible cycle phase change fluid, the method comprising:
providing a polar working fluid comprising metallic nanoparticles coated with a stimulus-responsive polymer having a predominantly hydrophilic first phase having a first hydrophilicity and a predominantly hydrophobic second phase with a second, lower hydrophilicity, wherein said polymer is switchable between said phases by application of a stimulus;
wherein said metallic nanoparticles are electrically charged; and
controlling said reversible cycle phase change fluid such that said polymer has said second phase and said coated nanoparticles cluster until an attractive force between said nanoparticles is balanced by a repulsive electrical force from said electrical charge of said nanoparticles; and
applying a stimulus to said polymer to switch said polymer to first phase such that the polymer absorbs said polar working fluid and bursts said clusters to provide a physical force and/or control a physical property of said reversible cycle phase change fluid.

20. (canceled)

21. (canceled)

22. (canceled)

23. (canceled)

24. (canceled)
